(19) United States
(12) Patent Application Publication
(10) Pub. No.: US 2018/0092487 A1
(43) Pub. Date: Apr. 5, 2018

(54) MICROWAVE MUG COOKER DEVICE

(71) Applicant: Enhance Product Development, Inc., Minneapolis, MN (US)

(72) Inventors: Ty Joseph Caswell, Zimmerman, MN (US); Trevor Lambert, Brooklyn Park, MN (US); Jonathan Dunn, Maple Grove, MN (US)

(21) Appl. No.: 15/723,733

(22) Filed: Oct. 3, 2017

Related U.S. Application Data
(60) Provisional application No. 62/404,620, filed on Oct. 5, 2016.

(51) Int. Cl. A47J 29/02; A47J 36/16

(52) U.S. Cl. CPC A47J 29/02; A47J 36/16

(57) ABSTRACT

Described herein is a microwaveable egg cooking device which provides an easy to use mixing and cooking vessel that also can be a serving dish once an egg is prepared and cooked in a microwave. In a related embodiment, the cooking vessel includes a handle that protrudes out for holding the cooking vessel that may still be hot from cooking.

### CLAIM OF PRIORITY

This application claims priority to and the benefit of U.S. Provisional Application with Ser. No. 62/404,620 and filed on Oct. 5, 2016, entitled MICROWAVE MUG COOKER DEVICE, which is hereby incorporated in its entirety.

### FIELD OF THE INVENTION

The invention relates generally to a microwaveable egg cooking device.

### BACKGROUND

Currently there are a number of solutions for cooking eggs. One of these solutions attempts to cook eggs on a stovetop, but this solution fails to meet the needs of a certain segment of the market because the process for scrambling eggs requires a bowl to scrabble an egg, a pan to fry the egg and a plate to serve and eat the egg. This generates a number of items that have to be washed by someone on the go or in a hurry. Another solution is for a user to attempt to cook an egg in a microwave in a regular microwaveable dish or bowl, but this solution is similarly unable to meet the needs of certain segments of the market because the taste quality of the final cooked egg may be lacking and the user could burn themselves on the dish the egg is cooked in because it is hot to the touch when coming directly out of the microwave oven. Therefore, there currently exists a need in the market for an apparatus and a method that allows a user to cook eggs in a safe manner, reduces the number of kitchen items used to cook the egg and allows for several different ways to prepare the eggs.

### SUMMARY OF THE INVENTION

It would be advantageous to have an apparatus that makes delicious eggs easily in a microwave oven. Furthermore, it would also be advantageous to have an apparatus that can scramble, poach and make perfectly shaped egg sandwiches. Still further, it would be advantageous to have an apparatus that cooks the eggs and can thereafter be a serving dish to reduce the number of dirty dishes. Therefore, there currently exists a need in the market for an apparatus that is a two-piece microwaveable mug and lid assembly that cooks eggs in several different ways.

Another example embodiment of the invention provides for a two-piece microwave mug assembly with a handle and a lid. The rotating, cam locking, removable (optional) lid with an integrated gasket has an over molded thumb grip pressure point to keep lid closed tightly when shaking contents in the mug assembly. The lid also has elongate members disposed on an inner surface of the lid facing the cavity vessel that serve as a built-in egg separator that also scrambles and fluffs the eggs when the user shakes the mug assembly prior to cooking the egg or eggs.

In one example embodiment, the mug assembly shape is designed to also mold the cooked eggs for sandwiches and for poaching eggs. The cooking apparatus disclosed herein fulfills the need for a device that makes several different types of egg dishes and cuts back on the amount of clean up in the kitchen when cooking is completed. Other foods requiring mixing or stirring before, during and after cooking also benefit from the cooking mug assembly disclosed herein, such as but limited to soups, sauces, various types of gravy, batters and cheese entrees. In yet another related embodiment, the cooking vessel of mug assembly is used to mix or stir up pancake batter for making pancakes in the microwave as the elongate prong members will serve to gently mix or stir the ingredients. In yet other related embodiments, the elongate prong or prong members are located on the bottom of the cooking vessel and/or on one or more sides of the cooking vessel. In various embodiments the elongate prongs have various shapes including posts or tabs and are not limited to a slot shape as shown in the figures herein.

In one example embodiment, there is provided a microwaveable cooking assembly including a mixing and cooking vessel having a cavity therein and an upper rim. The assembly also includes a lid configured to be located over the upper rim of the cooking vessel and enclose the vessel cavity, wherein the lid includes a least one elongate member configured to extend into the cooking vessel cavity so as to facilitate mixing of contents within the cooking vessel. In a related embodiment, the cooking assembly includes a plurality of elongate members located on the lid configured to extend into the vessel cavity so as to facilitate mixing of any food content within the cooking vessel.

In another example embodiment, there is provided a microwaveable cooking assembly including a mixing and cooking vessel having a cavity therein and an upper rim. The assembly also includes a lid configured to be located over the upper rim of the cooking vessel and enclose the vessel cavity, wherein the lid includes a least two elongate members configured to extend into the cooking vessel cavity so as to facilitate mixing of contents within the cooking vessel. The assembly further includes a handle member located on an outer surface of the cooking vessel. In a related embodiment, each of the elongate members of the cooking assembly has a front surface and a side surface, and wherein the side surface of the at least two of the elongate members are facing each other. In this example embodiment, the elongate members are disposed laterally adjacent each other in a semicircular configuration.

In another example embodiment, there is provided a method of mixing or stirring a food item in a mixing vessel including the steps of providing a mixing vessel body having a mixing cavity therein and an upper rim and providing a lid or cover member to be located over the upper rim of the mixing vessel body. The method also includes the step of providing a plurality of elongate members or prongs configured to extend into the mixing cavity and placing a food item within the mixing cavity and placing the lid member over the mixing vessel body. The method further includes the step of agitating the combined vessel body and lid so as to facilitate mixing of the food item by the elongate prongs. In a related embodiment, the elongate prongs are located on the lid member.

Among other things, it is an advantage of the invention to provide a microwaveable egg cooking device that does not suffer from any of the problems or deficiencies associated with prior solutions. It is still further an advantage of the invention to have a handle that stays cool to the touch when removing the device from the microwave and the handle that is ergonomic for easy holding while eating contents from the mug assembly.

In a related embodiment, the mug assembly is made from a glass, plastic or ceramic material or any other microwave resistant material. In yet another embodiment, the mug assembly is configured from a heat resistant material, such as (but not limited to) glass, plastic or ceramic or metal, for mixing/preparing the food items and then cooking the food contents on the stovetop or in the oven. In this example embodiment, the handle is configured to include an insulative handle or an insulative covering for the handle for grasping.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1A illustrates a perspective view of a microwaveable cooking assembly according to the teachings herein.

FIG. 1B illustrates the cooking assembly with an opened lid.

FIG. 1C illustrates a top perspective view of an inside surface of the lid with a plurality of elongate members.

FIG. 2A illustrates a handle of the mug assembly.

FIG. 2B illustrates a cooking cavity or inside of the mug assembly including a pour spout formed thereon.

FIG. 3A illustrates a top view of another example embodiment of a mug assembly with a composite handle and with the lid in a closed position.

FIG. 3B illustrates a perspective view of the mug assembly with the lid in an opened position and illustrating both halves of the composite handle.

FIG. 3C illustrates a cooking cavity or inside of the mug assembly and a slot arrangement for receiving a tab from the lid.

FIG. 3D illustrates a top perspective view of an inside surface of the lid with a tab that fits in the slot of the mug assembly and with another configuration of elongate members.

FIG. 4A illustrates a top perspective of the mug assembly including an egg boiler assembly.

FIG. 4B illustrates a perspective view of the egg boiler assembly with conjoined egg boiler members and a poker member.

FIG. 4C illustrates a top perspective of an inside surface of the egg boiler assembly.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The various embodiments described herein are directed to be a microwaveable egg mixing and cooking assembly. The cooking assembly is not limited to just mixing and cooking eggs and includes other foods. In addition, the cooking elements of the cooking the assembly and can be made of ceramic or glass or metal to facilitate cooking in an oven, so long as the user uses cooking mitts to handle the cooking vessel.

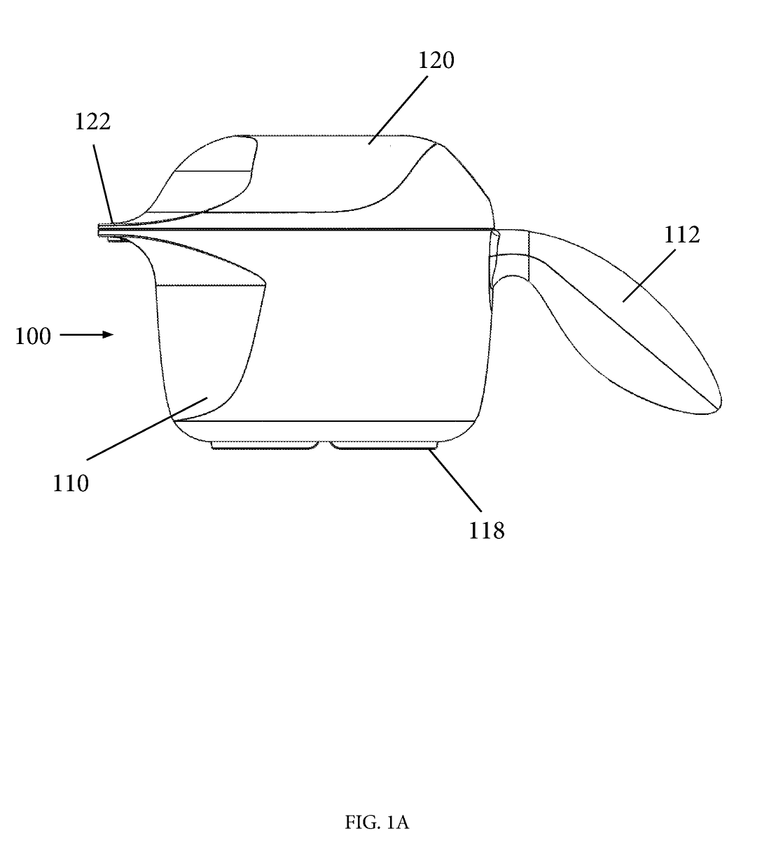

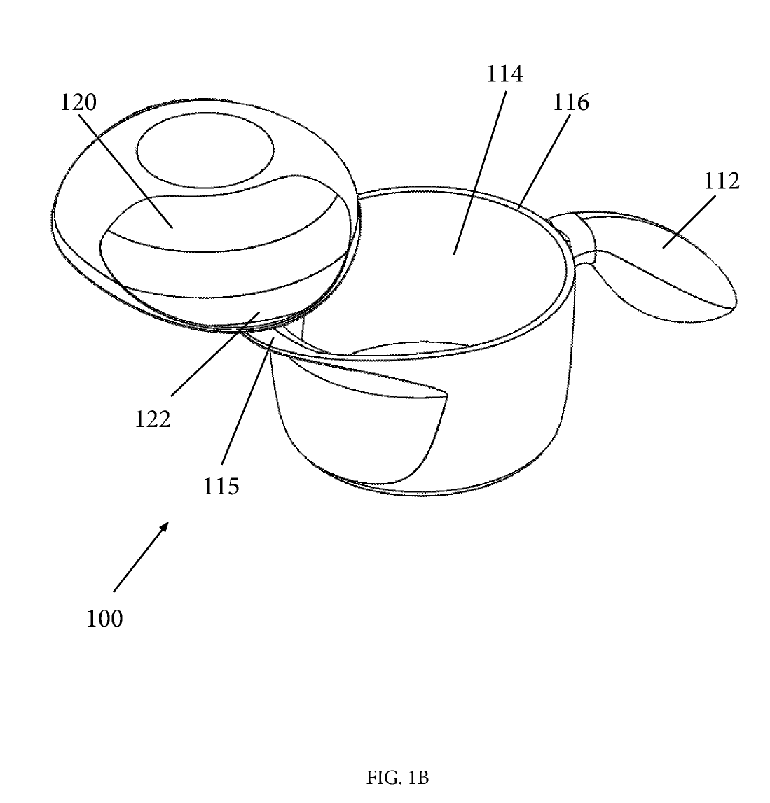

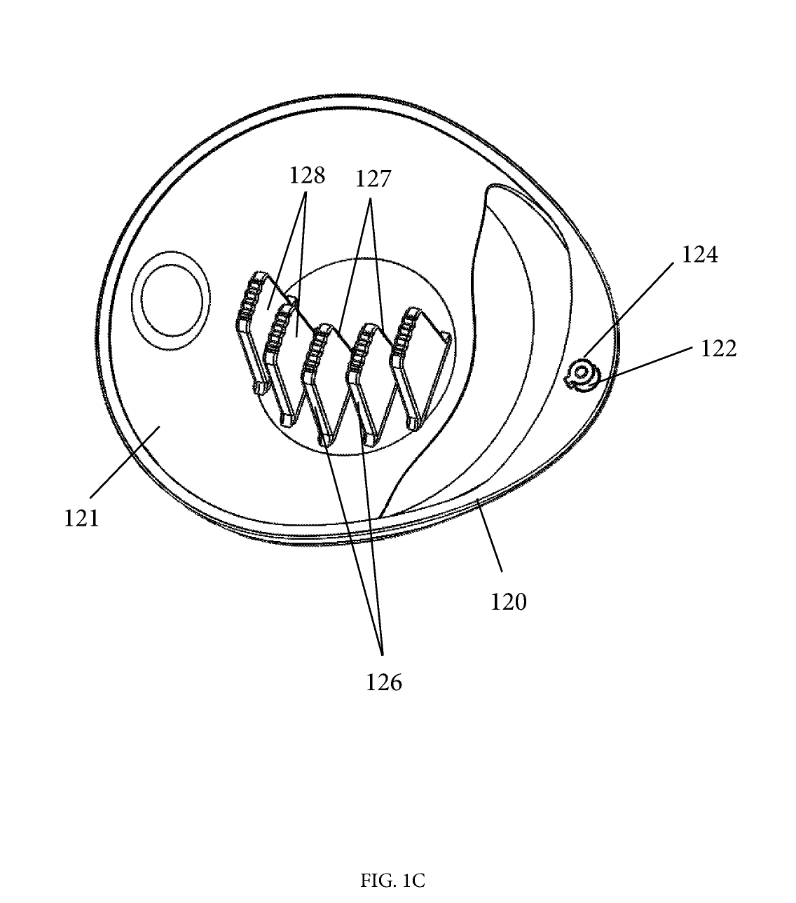

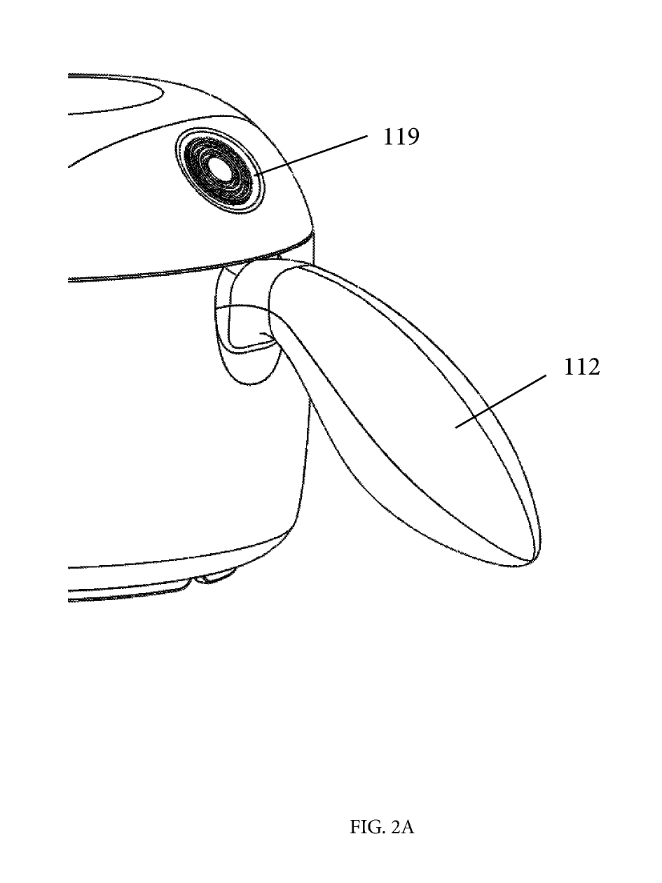

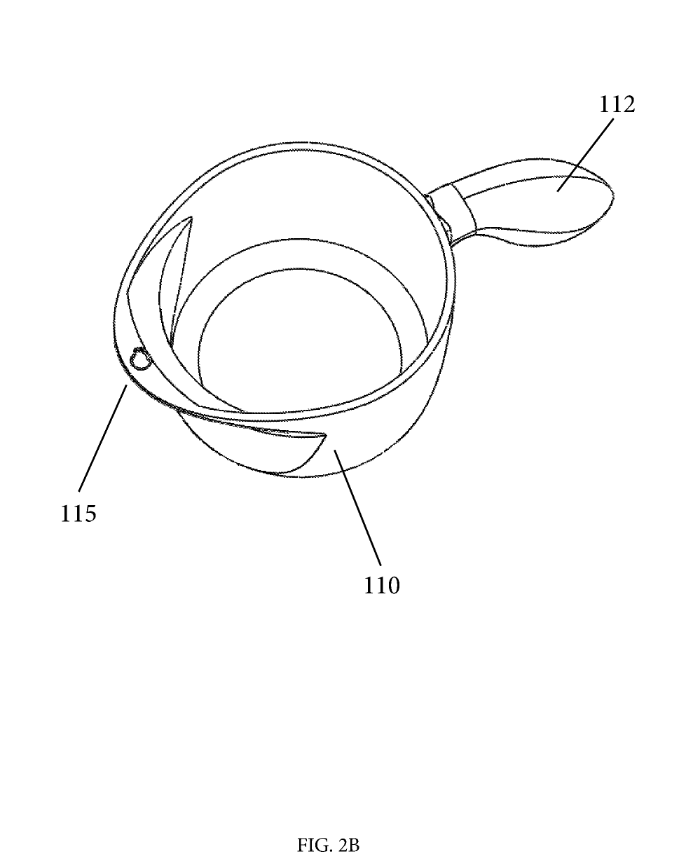

Referring now to the figures, FIGS. 1A-2B illustrate various views of a microwaveable cooking assembly 100 according to the teachings herein. Cooking and mixing assembly 100 includes a mixing and cooking vessel 110 (with an optional non-stick coating on the surface) having an optional handle 112 and a vessel cavity 114 therein, an upper rim 116 and a closed end (base) 118. Assembly 100 further includes a removable lid 120 configured to be located over upper rim 116 and enclosing vessel cavity 114. Removable lid 120 has an inner surface 121 disposed over and configured to cover cavity 114 which includes a least one elongate member 126 extending up from inside surface 121. In one example embodiment, elongate member 126 is configured to extend into cooking vessel cavity 114 when assembly 100 is closed so as to facilitate mixing of food contents located within the cooking vessel 110 when the food contents within cavity 114 are mixed or shaken. In this example embodiment, a plurality of prongs or elongate members 126, disposed on surface 121 in a semicircular configuration (but not limited to being in a semicircular configuration), have a side surface 127 and a front surface 128. In this example embodiment, front surface 128 of at least two of the elongate members 126 are facing each other. Side surfaces 127 of prong members 126 also serve as egg separators when an egg is placed against lid inner surface 121 and above the semicircular arrangement of prongs 126. In this example embodiment, a distal end of each of prong members 126 also include serrated ridges. When used as an egg separator, a portion of a surface of prong member 126 is used to crack the egg while side surfaces 127 serve as the egg separator when the egg is placed against lid inner surface 121. The egg whites stay in cavity 114 while the egg yolk can be placed on another dish.

In this example embodiment, an optional pour spout 115 is molded on vessel 110 to facilitate the pouring out of any contents from cavity 114. In this example embodiment of microwaveable cooking assembly 100, removable lid 120 and cooking vessel 110 include a pivot assembly 122 disposed on upper rim 116 to facilitate opening and closing of lid 120 over vessel cavity 114 (FIG. 1B). In one example embodiment, pivot assembly 122 includes a post 124 fitted through an aperture (not shown) in each of lid 120 and cooking vessel 110 to maintain the lid and cooking vessel in a closed relationship during mixing and cooking.

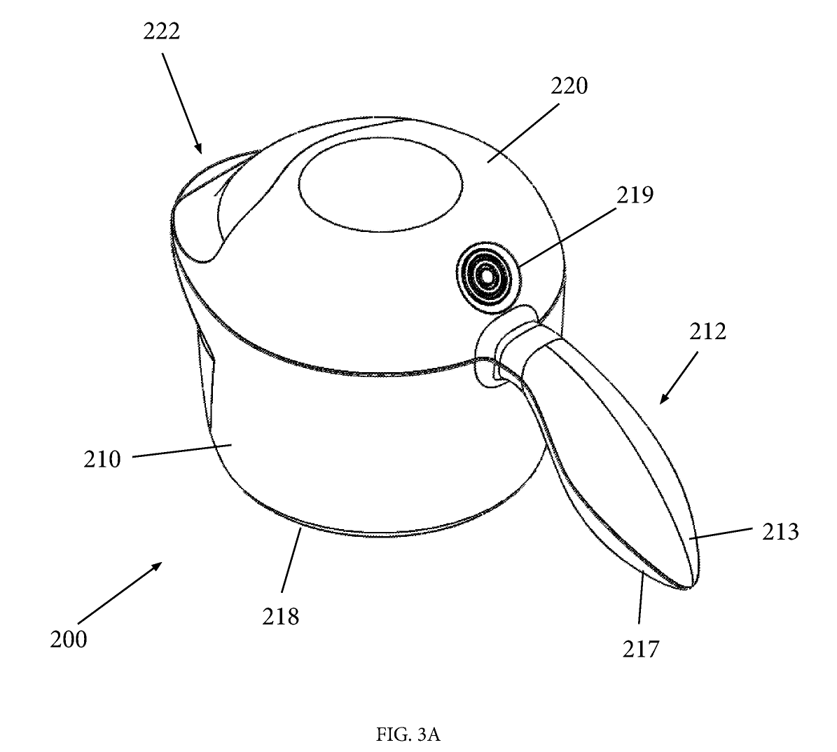

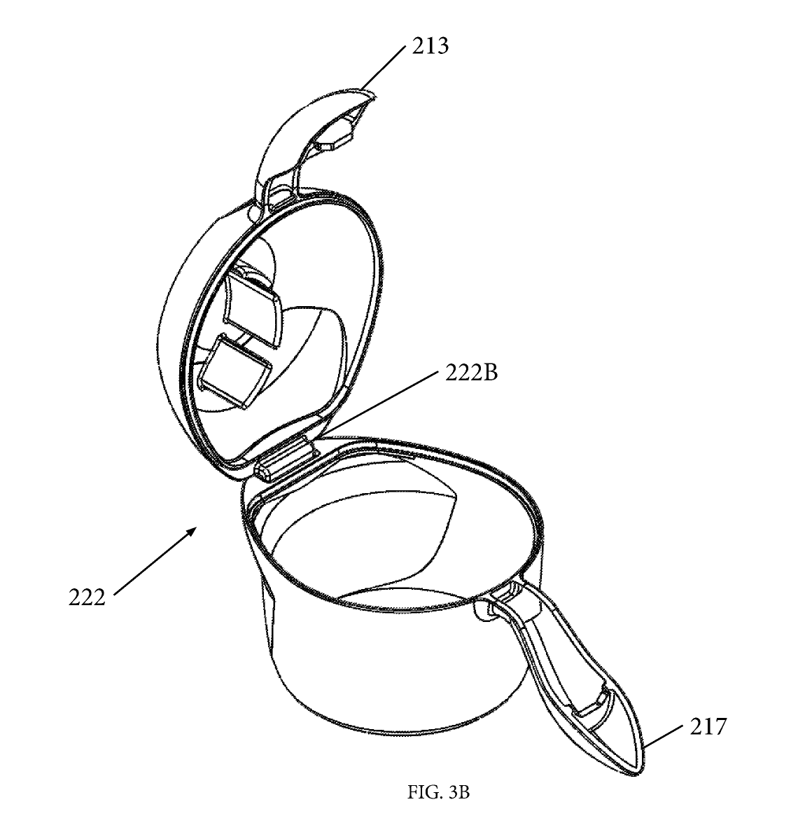

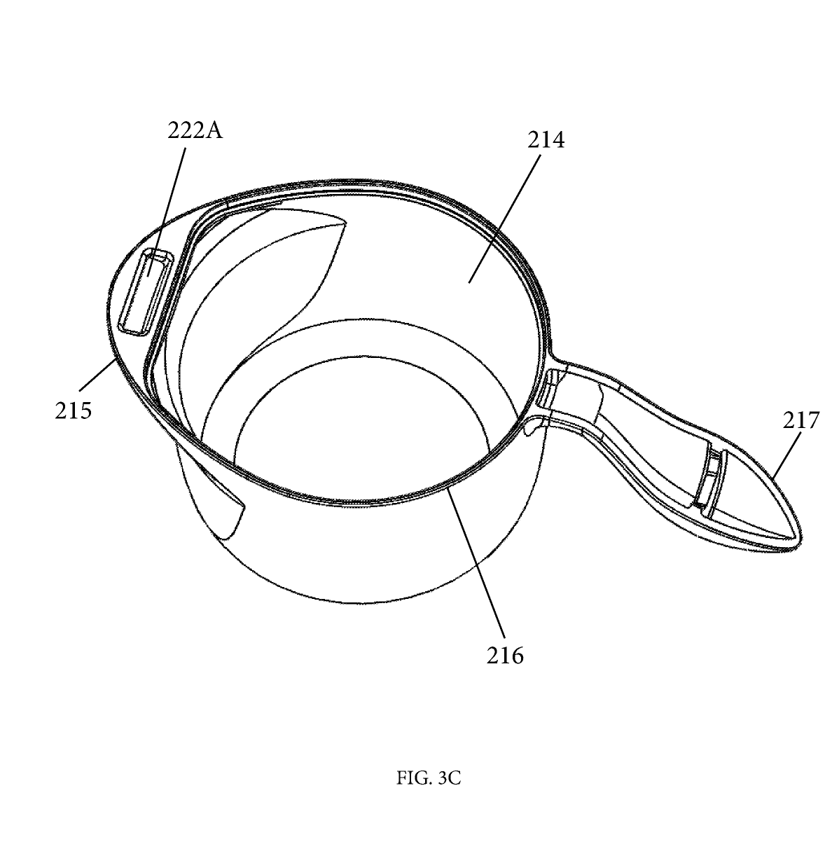

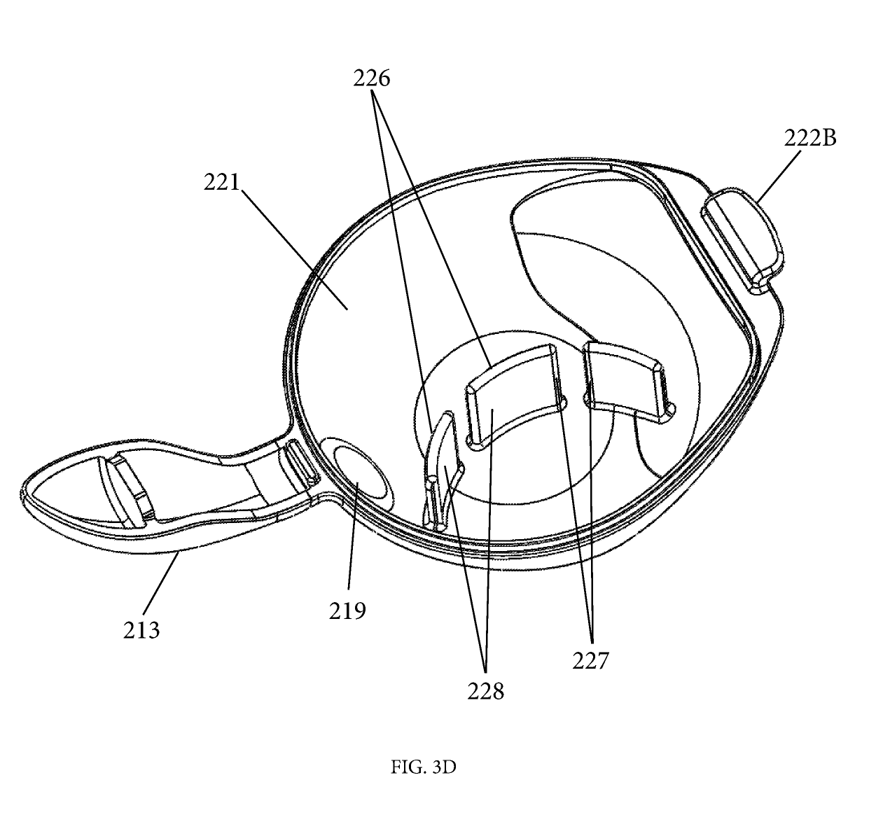

Referring now to FIGS. 3A-3D, there is illustrated another example embodiment of a cooking and mixing assembly 200 includes a mixing and cooking vessel 210 and a vessel cavity 214 therein (with an optional non-stick coating on the surface), cooking vessel 210 having a composite handle 212, an upper rim 216 and a closed end 218. Assembly 200 further includes a removable lid 220 configured to be located over upper rim 216 and enclosing vessel cavity 214. Composite handle 212 is formed from a lid handle portion 213 and a cooking vessel portion 217 when cooking assembly 200 is closed. To facilitate lid opening and closing of cooking assembly 200, there is included a cantilevering or hinging configuration 222 formed from a slot 222A formed in vessel 210 and located laterally away from cavity 214, along rim 216 and located directly opposite handle 212. Lid 220 includes a clip or hinging tab member 222B that fits into and engages slot 222A for pivoting lid 220 open and closed over cavity 214 and assists user in lid 220 staying closed during mixing and shaking of the food contents prior to cooking.

In one example embodiment, removable lid 220 has an inner surface 221 disposed over and configured to cover cavity 214 which includes a least one elongate member 226 extending up from surface 221. The elongate member 226 is configured to extend into cooking vessel cavity 214 when assembly 200 is closed so as to facilitate mixing of food contents located within the cooking vessel 210 when the food contents within cavity 214 are mixed or shaken. In this example embodiment, cooking vessel 210 also includes a molded in pour spout 215.

In this example embodiment, as illustrated in FIG. 3D, removable lid 220 includes on its inner surface 221 a plurality of elongate members 226 with gaps therebetween, formed in a semicircular configuration (but not necessarily limited to such configuration), and designed to extend into the vessel cavity 214 so as to facilitate mixing of any food content within the cooking vessel. Prongs or elongate members 226 have a side surface 227 and a front surface 228, such that side surface 227 of at least two of the elongate members 226 are facing each other. With this configuration, front surfaces 228 of prong members 226 support an egg when an egg is placed against lid inner surface 221 and above the semicircular arrangement of prongs 226. Although this embodiment illustrates three (3) prongs 226, the various embodiments described herein are not limited to three (3) and can be more or less prong members 126 or 226. These built in prongs or elongate members serve to scramble and fluff eggs (when contents of assembly 200 is shaken), separate egg whites from the yolk and then the mug shape makes perfectly shaped eggs for an egg breakfast sandwich. The user can also poach eggs in the mug when water is added.

In a related embodiment, the at least one elongate member 126 or 226 includes a wall member formed and disposed on an inside surface of the lid 120 or 220. The wall member still assists in mixing any food contained within either cooking assembly. In another related embodiment, the wall member includes at least one aperture (or a plurality of apertures to simulate a web or strainer) therethrough to facilitate flow through of a food item for mixing or when used as an egg or food separator.

When cooking assembly 100 or 200 is in use, handle 112 or 212 can also be used for shaking the mug to scramble eggs and is sufficiently cool to the touch when removing the mug from the microwave. In these example embodiments, lid 120 or 220 locks onto the mug or vessel 110 with a rotating cam lock or pivot assembly (or cantilevering configuration 222 of assembly 200) and the lid keeps food hot. The lid also allows for putting the entire mug assembly 100 or 200 with unfinished food in the refrigerator. In one example embodiment, referring to FIGS. 2A and 3A, an over molded thumb grip pressure point (concentric rings) 119 or 219 of assembly 100 or 200, respectfully, and an optional gasket on lid 120 (or 220) allows the user to hold the lid tightly closed when shaking, scrambling, and fluffing egg contents inside mug assembly 100 or 200.

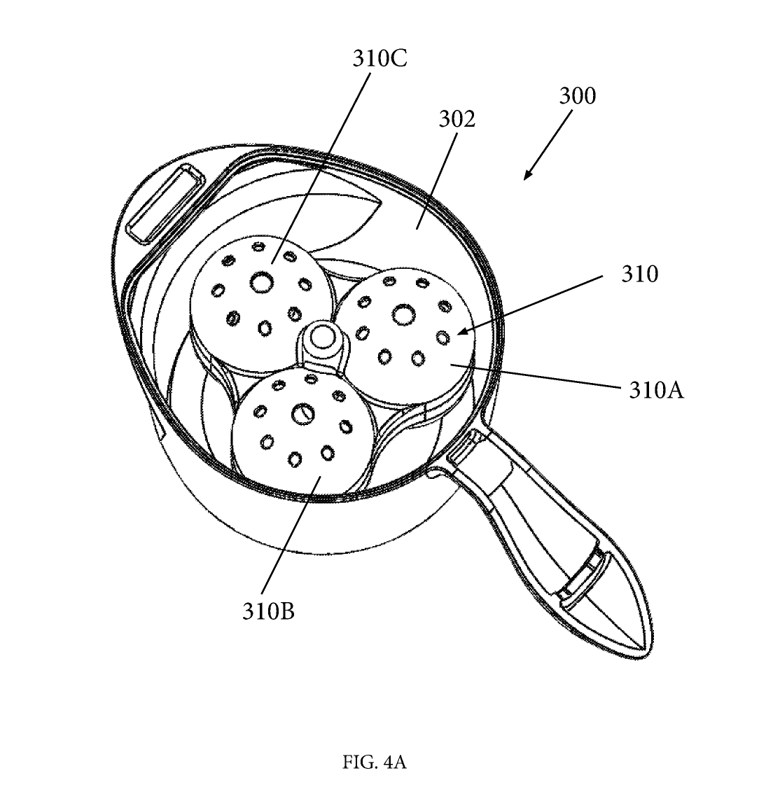

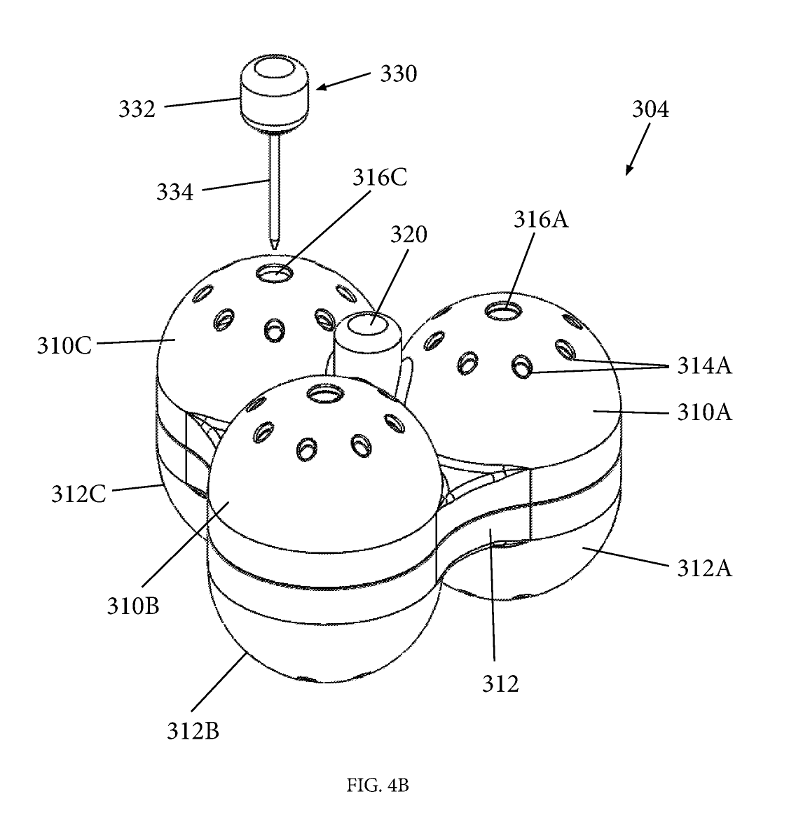

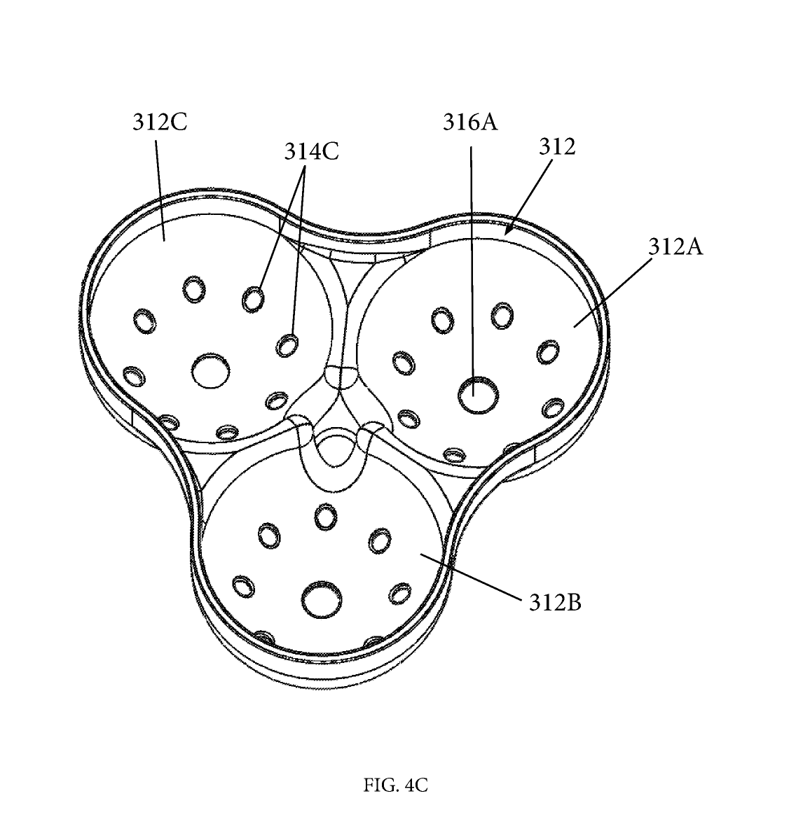

Referring now to FIGS. 4A-4C, in particular FIG. 4A illustrates a top perspective of a mug assembly 300 have a vessel 302 with an egg boiler assembly 304 disposed therein. Egg boiler assembly 304 facilitates the cooking of one or more eggs within vessel 302 when it is covered with a lid and placed in the microwave with water. In this example embodiment, eggs are cooked in boiler members 310A, 310B and 310C. FIG. 4B illustrates a perspective view of egg boiler assembly 304 outside of mug assembly 300 with the three conjoined egg boiler members, a center post 320 and a poker member 330. Referring briefly to FIG. 4C there is illustrated a top perspective of an inside surface of a bottom portion 312 of egg boiler assembly 304. Egg boiler assembly 304 is comprised of a bottom portion 312 having three egg-retaining cavities 312A, 312B and 312C, and apertures 314A, 314B and 314C for allowing boiling water and steam to flow through to the egg. Each egg cavity 312 further includes a vent hole 316A, 316B and 316C, respectively, by which poker member 330 is introduced having handle 332 and piercing needle 334. A top portion 310 is configured to mate with bottom portion 312, with the top portion having corresponding egg-retaining cavities 310A, 310B and 310C, and apertures 314B for allowing boiling water and steam to flow through to the egg. Top portion 310 further includes at least one vent hole 316A located at an apex of each of the cavities 310A, 310B and 310C. In this example embodiment, the bottom and top portions include a microwave shielding material with the microwave shielding material being made from aluminum mesh or foil or can comprise a microwave-resistant coating. In a related embodiment, the microwave shielding is optional.

In one example of a method of cooking scrambled eggs with egg whites only, assembly 100 includes on lid 120 an egg white separator formed from elongate members 126 built into underside of lid 120. A user simply flips lid 120 over to expose surface 121 and lays the lid on the counter, optionally uses one or more of prongs 126 to crack the egg and then drops the raw egg into lid surface 121 on one side of fork prongs 126 (in this example embodiment, prong members 126 have fork-like members on an upper surface; see FIG. 1C). The fork prongs of prong members 126 act as a fence or fingers keeping the egg yolk on one side while the egg white slips through the gaps between fork prongs members 126 to other side of lid, separate from egg yolk. The user then lifts lid from countertop and drops the egg white into mug, and then discards the separated egg yolk from other side of fork prong fence or fingers and into another container. In this example embodiment and referring to FIGS. 1B, there is also an integrated pour spout lip 115 on mug for pouring out contents if desired.

The following patents are incorporated by reference in their entireties: U.S. Pat. Nos. 4,413,167 and 5,293,021.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A microwaveable cooking assembly comprising:
a mixing and cooking vessel having a cavity therein and an upper rim; and
a lid configured to be located over the upper rim of the cooking vessel and enclose the vessel cavity, wherein the lid includes a least one elongate member configured to extend into the cooking vessel cavity so as to facilitate mixing of contents within the cooking vessel.

2. The microwaveable cooking assembly of claim 1 wherein the lid includes a plurality of elongate members configured to extend into the vessel cavity so as to facilitate mixing of any food content within the cooking vessel.

3. The microwaveable cooking assembly of claim 2 wherein the lid and the cooking vessel include a connecting assembly disposed on the upper rim to facilitate opening and closing of the lid over the vessel cavity.

4. The microwaveable cooking assembly of claim 3 wherein the connecting assembly includes a post fitted through an aperture in each of the lid and the cooking vessel to maintain the lid and cooking vessel in a closed relationship during mixing and cooking.

5. The microwaveable cooking assembly of claim 3 wherein the connecting assembly includes a hinging tab member on the lid fitted through a slot in the cooking vessel to maintain the lid and cooking vessel in a closed relationship during mixing and cooking.

6. The microwaveable cooking assembly of claim 1 further comprising a handle protruding from an outside surface of the cooking vessel.

7. The microwaveable cooking assembly of claim 1 further comprising a composite handle protruding from an outside surface of the cooking assembly, the handle comprised of a lid handle portion and a cooking vessel portion forming the composite handle upon closing joining the lid and the cooking vessel in a closed configuration.

8. The microwaveable cooking assembly of claim 2 wherein the plurality of elongate members are disposed laterally adjacent each other with small gaps therebetween.

9. The microwaveable cooking assembly of claim 8 wherein the plurality of elongate members are disposed laterally adjacent each other in a semicircular configuration.

10. The microwaveable cooking assembly of claim 8 wherein each of the plurality of elongate members has a front surface and a side surface, and wherein the front surface of at least two of the elongate members are facing each other.

11. The microwaveable cooking assembly of claim 8 wherein each of the plurality of elongate members has a front surface and a side surface, and wherein the side surface of at least two of the elongate members are facing each other.

12. The microwaveable cooking assembly of claim 7 wherein the composite handle includes cantilevering or hinging assembly comprised of a slot on an outer surface of the cooking vessel handle portion and a tongue or clip member protruding a perimeter of the lid handle portion, wherein the clip member engages the slot in the cantilevering configuration.

13. The microwaveable cooking assembly of claim 1 wherein the at least one elongate member includes a wall member disposed on an inside surface of the lid.

14. The microwaveable cooking assembly of claim 13 wherein the wall member includes at least one aperture therethrough to facilitate flow through of a food item.

15. A microwaveable cooking assembly comprising:
a mixing and cooking vessel having a cavity therein and an upper rim;
a lid configured to be located over the upper rim of the cooking vessel and enclose the vessel cavity, wherein the lid includes a least two elongate members configured to extend into the cooking vessel cavity so as to facilitate mixing of contents within the cooking vessel; and
a handle member located on an outer surface of the cooking vessel.

16. The microwaveable cooking assembly of claim 15 wherein each of the elongate members has a front surface and a side surface, and wherein the side surface of at least two of the elongate members are facing each other.

17. The microwaveable cooking assembly of claim 15 wherein the elongate members are disposed laterally adjacent each other in a semicircular configuration.

18. The microwaveable cooking assembly of claim 15 wherein the handle is a composite handle protruding from an outside surface of the cooking assembly, the handle comprised of a lid handle portion and a cooking vessel portion forming the composite handle upon closing joining the lid and the cooking vessel in a closed configuration.

19. A method of mixing or stirring a food item in a mixing vessel comprising:
providing a mixing vessel body having a mixing cavity therein and an upper rim;
providing a lid or cover member to be located over the upper rim of the mixing vessel body;
providing a plurality of elongate members or prongs configured to extend into the mixing cavity; and
placing a food item within the mixing cavity and placing the lid member over the mixing vessel body; and
agitating the combined vessel body and lid so as to facilitate mixing of the food item by the elongate prongs.

20. The method of claim 19, wherein the elongate prongs are located on the lid member.

21. An egg boiler assembly comprising:
a bottom portion having at least one cavity formed therein for retaining an egg; and
a top portion configured to mate with the bottom portion, the top portion having at least one corresponding cavity for retaining the egg, the top portion further including at least one vent hole located at an apex of each of the cavities; and
bottom and top portions including a microwave shielding material.

22. The egg boiler assembly of claim 21 further comprising a poker member configured to be inserted through at least one cavity.
